(19) United States
(12) Patent Application Publication
(10) Pub. No.: US 2024/0072243 A1
(43) Pub. Date: Feb. 29, 2024

(54) CARBON COMPOSITE FOR ELECTRODE OF BATTERY, BATTERY COMPRISING SAME, AND METHOD OF MANUFACTURING SAME

(71) Applicant: LG ENERGY SOLUTION, LTD., Seoul (KR)

(72) Inventors: Yo-Chan JEONG, Daejeon (KR); Chang-Hoon LEE, Daejeon (KR); Seung-Bo YANG, Daejeon (KR)

(21) Appl. No.: 18/128,982

(22) Filed: Mar. 30, 2023

(30) Foreign Application Priority Data
Aug. 31, 2022 (KR) 10-2022-0110385
Dec. 28, 2022 (KR) 10-2022-0187899

(51) Int. Cl. H01M 4/36; H01M 4/04; H01M 4/38; H01M 4/583; H01M 10/052; H01M 50/46

(52) U.S. Cl. CPC H01M 4/366; H01M 4/0471; H01M 4/382; H01M 4/583; H01M 10/052; H01M 50/46; H01M 2004/021

(57) ABSTRACT

A carbon composite for an electrode of a battery, a battery including the same, and a method of manufacturing the same are provided. The carbon composite comprises a porous carbon material, and vanadium nitride particles formed on a surface of the porous carbon material, and provides improved performance of the battery including the same. The method of manufacturing the same is capable of preparing catalyst particles uniformly distributed on the surface of the porous carbon material without using harmful gas or strong acid.

### CROSS-REFERENCE TO RELATED APPLICATIONS

This application claims priority to Korean Patent Application No. 10-2022-0110385 filed on Aug. 31, 2022 and Korean Patent Application No. 10-2022-0187899 filed on Dec. 28, 2022, the disclosures of which are incorporated herein by reference in their entirety.

### TECHNICAL FIELD

The present disclosure generally relates to the field of batteries, and more particularly, to a carbon composite for an electrode of a battery, a battery including the same, and a method of manufacturing the same.

### BACKGROUND

A lithium-sulfur battery is an energy storage device including a sulfur containing material having a sulfur-sulfur (S—S) bond for a positive electrode active material and a lithium metal for a negative electrode active material. Sulfur, a main component of the positive electrode active material, is abundant in nature and can be found around the world, is non-toxic, and has low atomic weight.

As secondary batteries are used in a wide range of applications including electric vehicles (EVs) and energy storage systems (ESSs), attention is drawn to lithium-sulfur batteries theoretically having higher energy storage density by weight (˜2,600 Wh/kg) than lithium-ion secondary batteries having lower energy storage density by weight (˜250 Wh/kg).

During discharging, lithium-sulfur batteries undergo oxidation at the negative electrode active material, lithium, by releasing electrons into lithium cation, and reduction at the positive electrode active material, the sulfur containing material, by accepting electrons. Through the reduction reaction, the sulfur containing material is converted to sulfur anion by the S—S bond accepting two electrons. The lithium cation produced by the oxidation reaction of lithium migrates to the positive electrode via an electrolyte, and bonds with the sulfur anion produced by the reduction reaction of the sulfur containing material to form a salt. Specifically, sulfur before the discharge has a cyclic S₈ structure, and it is converted to lithium polysulfide (Li₂Sₓ, x=8, 6, 4, 2) through the reduction reaction and is completely reduced to lithium sulfide (Li₂S).

The lithium polysulfide (Li₂Sₓ) produced during charging and discharging is soluble in electrolyte solution, and lithium polysulfide dissolution causes loss of the positive electrode active material (“shuttle effect”) and thereby causing degradation in capacity and battery life.

In order to overcome the problem of the lithium polysulfide dissolution, many studies have been conducted on impregnation of sulfur in pores of a variety of porous carbon materials for use in positive electrodes. In particular, studies have been mainly conducted on physical and chemical modifications of carbon materials having low specific surface area, since it requires high production costs to synthesize carbon having large specific surface area. However, even though these studies have presented some solutions to the lithium polysulfide dissolution problem, they fail to promote the conversion reaction of lithium polysulfide to lithium sulfide (Li₂S).

The present disclosure is directed to overcoming one or more of these challenges. The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

According to certain aspects of the disclosure, a carbon composite for an electrode of a battery, a battery including the same, and a method of manufacturing the same for promoting conversion reaction of lithium polysulfide to lithium sulfide are provided in this disclosure.

### Technical Solution

In one aspect, the disclosure relates to a carbon composite for an electrode of a battery, and the carbon composite may comprise: a porous carbon material; and vanadium nitride particles formed on a surface of the porous carbon material.

In some embodiments, an average particle size of the vanadium nitride particles may be 200 nm or less.

In some embodiments, a specific surface area of the carbon composite may be 250 m²/g or more.

In some embodiments, a pore volume of the carbon composite may be 1.0 cm³/g or more.

In some embodiments, the porous carbon material may comprise micropores having pore diameters equal to or larger than 0.2 nm and smaller than 2 nm, mesopores having pore diameters from 2 nm to 50 nm, and macropores having pore diameters larger than 50 nm and equal to or smaller than 300 nm, and a volume ratio of the micropores and mesopores to the macropores may be 9:1 to 1:5.

In some embodiments, a content of the vanadium nitride particles in the carbon composite may be 3 parts by weight or more and 50 parts by weight or less based on 100 parts by weight of the carbon composite.

In some embodiments, the porous carbon material may comprise carbon nanotubes (CNT), reduced graphene oxide (RGO), carbon black, or activated carbon.

In some embodiments, the porous carbon material may comprise carbon nanotubes. The carbon nanotubes may be entangled carbon nanotubes. The carbon nanotubes may comprise defects including vacancies or functional groups containing oxygen.

In some embodiments, a Raman peak intensity ratio, I_{G}/I_{D}, of the carbon composite may be 2.0 or less, wherein I_{G} is a peak intensity for a crystalline portion and I_{D} is a peak intensity for a non-crystalline portion in a Raman spectrum.

In some embodiments, the carbon composite may further comprise N-doped amorphous carbon between a surface of the vanadium nitride particles and the surface of the porous carbon material. A molar ratio of the vanadium nitride particles to the N-doped amorphous carbon may be from 20:1 to 1:1.

In another aspect, the disclosure relates to a method of manufacturing a carbon composite for an electrode of a battery, and the method may comprise: forming a mixture of a porous carbon material, vanadium nitride or its precursor, a reducing agent, and a solvent; removing the solvent by filtering the mixture and drying the filtered mixture; and thermally treating the dried filtered mixture in an inert atmosphere. The thermally treating may comprise a first thermal treatment performed at 350 to 650° C. and a second thermal treatment performed at 650 to 1400° C.

In some embodiments, when forming the mixture, the porous carbon material may comprise carbon nanotubes.

In some embodiments, NH₃, HF, or acid having pKa of 4.0 or less may not be used in manufacturing the carbon composite.

In yet another aspect, the disclosure relates to an electrode active material for an electrode of a battery, and the electrode active material may comprise the carbon composite as described above; and a sulfur containing material.

In some embodiments, the sulfur containing material may comprise an elemental sulfur (S₈), Li₂Sₙ where n≥1, disulfide compounds, organosulfur compounds, carbon-sulfur polymers (C₂Sₓ)ₙ where x=2.5 to 50 and n≥2, or a mixture of two or more thereof.

In some embodiments, a content ratio of the sulfur containing material to the carbon composite may range from 1:1 to 9:1 by weight.

In a further aspect, the disclosure relates to an electrode for a battery, and the electrode may comprise a current collector; and an active material layer formed on a surface of the current collector.

In some embodiments, the active material layer may comprise the electrode active material as described above, a binder, and a conductive material.

In some embodiments, a content of the conductive material may be 0.01 to 30 parts by weight based on 100 parts by weight of the active material layer.

In some embodiments, the active material layer may comprise a porous carbon support and a sulfur containing material supported in pores thereof, a binder, and a conductive material, and the conductive material may comprise the carbon composite as described above.

In some embodiments, the electrode may be a positive electrode of a lithium-sulfur battery (“Li—S battery”).

In a yet further aspect, the disclosure relates to a battery, which may comprise: a first electrode; a second electrode; a separator between the first electrode and the second electrode; and an electrolyte.

In some embodiments, the first electrode of the battery may comprise a carbon composite, and the carbon composite may comprise a porous carbon material and vanadium nitride particles formed on a surface of the porous carbon material.

In some embodiments, the first electrode of the battery may comprise the active material layer comprising a porous carbon support and a sulfur containing material supported in pores thereof, a binder, and the carbon composite described above as a conductive material.

In yet another aspect, the disclosure relates to a lithium-sulfur battery, which may comprise: a first electrode comprising a carbon composite and a sulfur containing material; a second electrode comprising a lithium metal; a separator between the first electrode and the second electrode; and an electrolyte, and the carbon composite may comprise a porous carbon material and vanadium nitride particles formed on a surface of the porous carbon material.

### Advantageous Effects

The carbon composite according to an embodiment of the present disclosure can be used as a carrier of sulfur containing materials or as a conductive material for a lithium-sulfur battery and is capable of promoting conversion reaction of lithium polysulfide (LiPS, Li₂Sₓ, 2≤x≤8) to lithium sulfide (Li₂S), and thereby providing improved performance of the battery including the same.

More specifically, the carbon composite according to the present disclosure, which includes VN catalysts well distributed on the porous carbon material and having decreased particle size and has increased specific surface area, is capable of enhancing kinetics of conversion reaction of LiPS to Li₂S, and thereby preventing overvoltage and capacity degradation caused by slow kinetics of the conversion reaction.

In addition, the method of manufacturing the carbon composite according to an exemplary embodiment of the present disclosure can prepare catalyst particles uniformly distributed and supported on the surface of the porous carbon material without using harmful gases such as NH₃ or strong acids such as HF or acid having pKa of 4.0 or less.

It is to be understood that both the foregoing general description and the following detailed description are exemplary and explanatory and are not restrictive of the disclosed embodiments, as claimed.

### BRIEF DESCRIPTION OF DRAWINGS

The accompanying drawings, which are incorporated in and constitute a part of this specification, illustrate various exemplary embodiments and together with the description, serve to explain the principles of the disclosed embodiments, and the present disclosure should not be construed as being limited to the accompanying drawings.

FIG. 1 is a graph showing the specific surface area of a carbon composite according to Example 1, Example 2, and Comparative Example 1 of the present disclosure.

FIG. 2 is a scanning electron microscopy (SEM) image of a carbon composite according to Example 1 of the present disclosure.

FIG. 3 is a SEM image of a carbon composite according to Example 2 of the present disclosure.

FIG. 4 is a SEM image of an observed carbon composite according to Comparative Example 1 of the present disclosure.

FIG. 5 is a graph showing results of charge/discharge performance evaluation of a lithium-sulfur battery according to Examples 3 and 4 and Comparative Example 5 of the present disclosure.

FIG. 6 is a graph showing results of charge/discharge performance evaluation of a lithium-sulfur battery according to Comparative Examples 3 and 5 of the present disclosure.

FIG. 7 is a graph showing results of charge/discharge performance evaluation of a lithium-sulfur battery according to Comparative Examples 3 and 5 of the present disclosure.

FIG. 8 is a graph showing results of performance evaluation of a lithium-sulfur battery according to Example 5 and Comparative Example 4 of the present disclosure.

FIG. 9 is a graph showing results of performance evaluation of a lithium-sulfur battery according to Example 5 and Comparative Example 4 of the present disclosure.

### DETAILED DESCRIPTION

Further aspects, features, and advantages of the present disclosure will become apparent from the detailed description which follows.

As used herein, the singular forms “a”, “an” and “the” are intended to include the plural forms as well, unless the context clearly indicates otherwise. Additionally, the use of “or” is intended to include “and/or” and not the “exclusive” sense of “either/or” unless the context clearly indicates otherwise.

As used herein, “about” is a term of approximation and is intended to include minor variations in the literally stated amounts, as would be understood by those skilled in the art. Such variations include, for example, standard deviations associated with techniques commonly used to measure the amounts of the constituent elements or components of an alloy or composite material, or other properties and characteristics. All of the values characterized by the above-described modifier “about,” are also intended to include the exact numerical values disclosed herein. Moreover, all ranges include the upper and lower limits.

Any compositions described herein are intended to encompass compositions which consist of, consist essentially of, as well as comprise, the various constituents identified herein, unless explicitly indicated to the contrary.

As used herein, the recitation of a numerical range for a variable is intended to convey that the variable can be equal to any value(s) within that range, as well as any and all sub-ranges encompassed by the broader range. Thus, the variable can be equal to any integer value or values within the numerical range, including the end-points of the range. As an example, a variable which is described as having values between 0 and 10, can be 0, 4, 2 to 6, 2.75, 3.19 to 4.47, etc.

Unless indicated otherwise, each will of the individual features or embodiments of the present specification are combinable with any other individual feature or embodiment that are described herein, without limitation. Such combinations are specifically contemplated as being within the scope of the present disclosure, regardless of whether they are explicitly described as a combination herein.

Technical and scientific terms used herein have the meaning commonly understood by one of skill in the art to which the present description pertains, unless otherwise defined. Reference is made herein to various methodologies and materials known to those of skill in the art.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus.

The term “composite” as used herein refers to a combination of two or more materials that have physically. or chemically different phases and exert more effective functions.

The term “polysulfide” as used herein is the concept including “polysulfide ion (Sₓ²⁻, x=8, 6, 4, 2)” and “lithium polysulfide (Li₂Sₓ or LiSₓ, x=8, 6, 4, 2)”.

Regarding the properties described herein, in case that measurement conditions and methods are not described in detail, the properties are measured by the measurement conditions and methods commonly used by those having ordinary skill in the corresponding technical field.

According to an aspect of the present disclosure, provided herein is a carbon composite for an electrode of a battery. The use of the carbon composite is not limited to a particular application, but in particular, the carbon composite is preferably used as a conductive material or a porous support for impregnation of sulfur containing material for a positive electrode in a lithium-sulfur secondary battery.

The carbon composite according to an aspect of the present disclosure comprises a porous carbon material, and vanadium nitride particles formed on a surface of the porous carbon material. During charging/discharging of lithium-sulfur batteries, in general, lithium polysulfide dissolution occurs at the positive electrode, and when the carbon composite according to an aspect of the present disclosure is applied as at least one of a conductive material or a carrier of sulfur containing material in a lithium-sulfur battery, the vanadium nitride particles included in the carbon composite act as catalysts to rapidly convert lithium polysulfide to lithium sulfide, thereby preventing dissolution of lithium polysulfide in the electrolyte solution.

The vanadium nitride (VN) is a compound of nitrogen and vanadium. The carbon composite according to the present disclosure comprises vanadium nitride particles formed on the surface of the porous carbon material.

In an embodiment of the present disclosure, the vanadium nitride particles may be those having catalytic activity on oxidation and reduction reactions for one or more selected from the group consisting of sulfur (S₈), lithium sulfide (Li₂S), lithium polysulfide (Li₂Sₓ, 2≤x≤8) and disulfide compound.

In an embodiment of the present disclosure, the vanadium nitride particles may be disposed on at least one of the outer surface of the porous carbon material or the inner surface of the pores. Preferably, the vanadium nitride particles may be bonded to the outer surface of the porous carbon material by adsorption.

For example, the carbon nanotube is a tube made of carbon connected in a hexagonal shape, and the vanadium nitride particles may be formed on the inner surface and/or the outer surface of the carbon nanotube having the tube shape, and in particular, may be present on the outer surface of the carbon nanotube. Here, the method of placing the vanadium nitride on the surface of the porous carbon material is not limited to a particular method, but for example, the vanadium nitride may be attached to or deposited on the surface of the porous carbon material.

In an exemplary embodiment of the present disclosure, an average particle size of the vanadium nitride particles may be 200 nm or less. In other words, the average particle size of the vanadium nitride particles may be 200 nm or less, and specifically, the average particle size may be 190 nm or less, 180 nm or less, 170 nm or less, 160 nm or less or 20 nm or less. Additionally, the average size of the vanadium nitride particles may be 1 nm or more or 2 nm or more.

When the average particle size of the vanadium nitride particles satisfies the above-described range, the specific surface area of the vanadium nitride particles that act as catalysts increases, thereby improving the reaction with lithium polysulfide, and the surface is not completely covered with lithium sulfide produced during discharging, thereby allowing reversible reaction, and a larger amount of catalysts may be present on the surface of the porous carbon material.

The average size of the vanadium nitride particles may be measured by XRD analysis as described above, and may be derived using a Scherrer equation.

In the present disclosure, the “particle size Dn” refers to a particle size at n % of cumulative particle size distribution. D50 refers to a particle size at 50% of cumulative particle size distribution, namely, the average particle size, D90 is a particle size at 90% of cumulative particle size distribution, and D10 is a particle size at 10% of cumulative particle size distribution.

The particle size Dn may be measured using a laser diffraction method. Specifically, the particle size distribution is calculated by dispersing a target powder in a dispersion medium and measuring a diffraction pattern difference according to particle size when particles pass through a laser beam using a commercially available laser diffraction particle size measurement device (for example, Microtrac S3500). D10, D50 and D90 may be measured by calculating the particle diameter at 10%, 50% and 90% of cumulative particle size distribution in the measurement device.

In an exemplary embodiment, a specific surface area of the carbon composite may be 250 m²/g or more.

Specifically, the specific surface area of the carbon composite may be 260 m²/g or more, 270 m²/g or more, 280 m²/g or more, 290 m²/g or more or 300 m²/g or more, and 400 m²/g or less or 500 m²/g or less.

When the specific surface area of the carbon composite meets the above-described range, a sufficient amount of vanadium nitride may be present on the surface of the carbon composite, it is possible to improve the conversion performance of lithium polysulfide to lithium sulfide by the sufficient amount of vanadium nitride on the surface, and the surface of the porous carbon material is not completely covered with lithium polysulfide or lithium sulfide produced during discharging, thereby allowing reversible reaction.

The specific surface area is measured by the BET method, and specifically, may be calculated from the amount of adsorbed nitrogen gas under liquid nitrogen temperature (77K) using BEL Japan's BELSORP-mino II.

In an exemplary embodiment, a pore volume of the carbon composite may be 1.0 cm³/g or more, and specifically, may be 1.1 cm³/g or more, 1.2 cm³/g or more, 1.3 cm³/g or more or 1.4 cm³/g or more, and 2.5 cm³/g or less, 2.7 cm³/g or less, 3.0 cm³/g or less. When the pore volume of the carbon composite meets the above-described range, a sufficient amount of vanadium nitride particles that act as catalysts may be present on the surface of the porous carbon material, and it is possible to improve the conversion performance of lithium polysulfide to lithium sulfide by the sufficient amount of vanadium nitride catalysts on the surface, and the surface is not completely covered with lithium sulfide produced during discharging, thereby allowing reversible reaction, and the electrolyte is sufficiently impregnated in the pores, thereby ensuring ionic conductivity.

The pore volume may be measured using AUTOSORB iQ series (Quantachrome) in accordance with ASTM D4641, and the pore volume may be a measured value by calculating through N₂ isotherm analysis obtained based on adsorption of liquid nitrogen.

In an exemplary embodiment, the porous carbon material may comprise micropores having pore diameters equal to or larger than 0.2 nm and smaller than 2 nm, mesopores having pore diameters from 2 nm to 50 nm, and macropores having pore diameters larger than 50 nm and equal to or smaller than 300 nm, and a volume ratio of the micropores and mesopores to the macropores may be 9:1 to 1:5.

In an exemplary embodiment, the average pore size of the carbon composite may be 10 nm or more, 15 nm or more or 50 nm or less, 70 nm or less, 100 nm or less. When the average pore size of the carbon composite meets the above-described range, it is possible to effectively adsorb lithium polysulfide, and make the electrolyte's access to the pores easy, thereby maintaining the optimal ionic conductivity, resulting in improved reactivity.

Here, the average pore size of the pores in the carbon composite may be, for example, determined by calculating through N₂ isotherm analysis based on adsorption of liquid nitrogen.

In an exemplary embodiment, a content of the vanadium nitride particles in the carbon composite may be 3 parts by weight or more and 50 parts by weight or less based on 100 parts by weight of the carbon composite, and specifically, may be included in an amount of 3 to 40 parts by weight, 3 to 30 parts by weight, 40 to 50 parts by weight, 35 to 50 parts by weight, 10 to 40 parts by weight or 20 to 30 parts by weight based on 100 parts by weight of the carbon composite. When the amount of the vanadium nitride particles is included in the above-described range, the vanadium nitride particles may convert lithium polysulfide to lithium sulfide quickly, prevent the dissolution of lithium polysulfide in the electrolyte solution, and maintain the optimal resistance and weight.

In an exemplary embodiment of the present disclosure, the carbon composite may comprise a small amount of VₓO_{y} (0<x<2. 0<y<5) formed as a by-product when the vanadium nitride particles are formed. In this instance, the amount may be measured by calculating the residual mass at 950° C. using ThermoGravimetric Analysis (TGA).

In an exemplary embodiment of the present disclosure, the vanadium nitride particles may be coated with a carbon layer. Specifically, the carbon layer may be 5 nm or less in thickness, and the thickness of the carbon layer may be measured by TEM. When the thickness of the carbon layer meets the above-described range, it is possible to increase the stability of the vanadium nitride catalysts while maintaining the effect of the catalysts.

The carbon layer coated on the vanadium nitride may be 1 to 3-layered or 1 to 5-layered. In this instance, the total thickness of the carbon layer may be 5 nm or less.

In an embodiment of the present disclosure, the porous carbon material may have a role of a support supporting the vanadium nitfide particles as a catalyst.

In an exemplary embodiment of the present disclosure, the porous carbon may be crystalline at least in part or in whole to activate the catalytic activity of the vanadium nitride as the catalyst. For example, when an amorphous porous carbon material is used as at least a portion of a conductive material and/or a positive electrode active material, the amorphous carbon portion acts as resistance in an electrochemical reaction of a battery and may cause degradation of battery performance. Accordingly, when the porous carbon material is at least partially or wholly crystalline, it may serve to reduce resistance in an electrode using the porous carbon material and improve catalytic activity by the vanadium nitride particles, but the mechanism of the present invention is not limited thereto.

The degree of crystallinity of the porous carbon material may be measured by X-Ray Diffraction (XRD) analysis. ‘XRD’ is the analysis of diffraction (black condition: 2d sin θ=nλ: the distance between 2 planes is d, an angle at which a plane is formed with X-ray is θ, an arbitrary integer is n, and the wavelength of X-ray is λ) resulting by scattering and interference of X-ray by electrons around atoms when a sample is irradiated with X-ray, and is used to determine the phase, quantity, crystal size or crystallinity of the components.

For example, when at least one independent peak appears in XRD spectrum, it can be seen that the porous carbon material is crystalline at least in part. In this instance, in the independent peak, a signal is measured 1 time or more, 1.5 times or more, 2 times or more, 5 times or more or 10 times or more, compared to noise.

In an exemplary embodiment of the present disclosure, in case that the porous carbon material is crystalline at least in part, it has higher elasticity than amorphous carbon materials. Here, for example, the amorphous carbon materials may be the carbon material disclosed by Liu at al. Nanoscale, 2018, 10, 5246-5253.

When the porous carbon material is crystalline in whole, it may have higher elasticity than amorphous carbon materials.

In an embodiment of the present disclosure, the porous carbon material may comprise the micropores in the outer surface and inside, and the average diameter of the micropores may range, for example, from 1 nm to 200 nm, for example, from 1 nm to 100 nm, from 10 nm to 80 nm or from 20 nm to 50 nm. The average diameter of the pores may be measured in accordance with ISO 15901:2019 known in the corresponding technical field, but is not limited thereto.

Additionally, in an embodiment of the present disclosure, the porosity (or void fraction) of the porous carbon material may range from 10% to 90% of the total volume of each porous carbon material. The porosity of the porous carbon material may be measured by the method in accordance with ISO 15901:2019 known in the corresponding technical field, but the measurement method is not limited thereto.

In an embodiment of the present disclosure, the pore volume of the porous carbon material may be, for example, 1 cm³/g to 20 cm³/g or 1 cm³/g to 10 cm³/g. The pore volume may be, for example, a value calculated and measured through N2 isotherm analysis obtained based on adsorption of liquid nitrogen. When the pore volume of the porous carbon material meets the above-described range, a sufficient amount of vanadium nitride particles that act as catalysts may be present on the surface of the porous carbon material.

The pore volume may be measured using AUTOSORB iQ series (Quantachrome) in accordance with ASTM D4641, and the pore volume may be a measured value by calculating through N₂ isotherm analysis obtained based on adsorption of liquid nitrogen.

In an embodiment of the present disclosure, for example, the porous carbon material may have the specific surface area of 100 to 2000 m²/g, 300 to 2000 m²/g, 400 to 1800 m²/g, 450 to 1500 m²/g or 500 to 1200 m²/g. The specific surface area may be measured by the BET method in accordance with ISO 15901:2019 known in the corresponding technical field, but is not limited thereto. When the specific surface area of the porous carbon material meets the above-described range, a sufficient amount of vanadium nitride particles that act as catalysts may be present on the surface of the porous carbon material.

In an embodiment of the present disclosure, the porous carbon material may comprise or consist of one or more of the group consisting of carbon nanotubes (CNT), graphene, graphene oxide (GO), reduced graphene oxide (rGO), carbon black, graphite, graphite nanofiber (GNF), carbon nanofiber (CNF), activated carbon fiber (ACF), natural graphite, artificial graphite, expanded graphite, activated carbon and fullerene.

In an exemplary embodiment, the porous carbon material may comprise carbon nanotubes and reduced graphene oxide.

In an exemplary embodiment, the porous carbon material may be doped with nitrogen, oxygen or phosphorus.

In an exemplary embodiment, the porous carbon material may comprise carbon nanotubes doped with nitrogen, oxygen or phosphorus; reduced graphene oxide doped with nitrogen, oxygen or phosphorus; or a mixture thereof.

The carbon nanotube is a tube made of carbon connected in a hexagonal shape. The tube made of carbon has typically a diameter of several nanometers, such as from 1 to 100 nm. Here, the length of the respective carbon nanotubes is not particularly limited.

According to an exemplary embodiment of the present disclosure, the carbon nanotubes may be classified into single-walled carbon nanotubes (SWCNT) or multi-walled carbon nanotubes (MWCNT) according to the number of carbon atom layers (also known as ‘carbon walls’) in their structures. In an embodiment of the present disclosure, when each of the first porous carbon material and the second porous carbon material optionally comprises carbon nanotubes, the carbon nanotubes may comprise at least one of single-walled carbon nanotubes (SWCNT) or multi-walled carbon nanotubes (MWCNT).

In another embodiment of the present disclosure, the carbon nanotubes may exist such that two or more carbon nanotubes come into close contact and get entangled with each other by their cohesion strength. In particular, in an embodiment of the present disclosure, the carbon nanotubes may be provided in the form of a carbon nanotube dispersion in which carbon nanotubes are dispersed as a single strand in a dispersion medium, but may be provided in the form of secondary structure or an agglomerate of carbon nanotubes of primary structure.

In this aspect, when the porous carbon material optionally comprises carbon nanotubes, the carbon nanotubes may comprise at least one of a bundled secondary structure or an entangled secondary structure.

The bundled secondary structure of the carbon nanotubes is an agglomerate of primary structures oriented in the lengthwise direction of the carbon nanotubes by the cohesion strength between carbon, each primary structure being single-stranded carbon nanotubes, and may be referred to as bundled CNT.

The entangled secondary structure of the carbon nanotubes is a randomly entangled and agglomerated form of primary structures in a spherical shape, each primary structure being single-stranded carbon nanotubes, and may be referred to as entangled CNT. The entangled CNT may have the improved porosity by interstitial volume formed by the entanglement of the carbon nanotubes of primary structure, compared to the carbon nanotubes of primary structure.

The carbon nanotubes included in the carbon composite may comprise a twisted carbon nanotube (carbon nanotube strand), and may comprise entangled carbon nanotubes. As described above, the carbon nanotubes included in the carbon composite may comprise one or more carbon nanotubes twisted or entangled, and the carbon composite may have a porous structure having spaces between the carbon nanotubes. In addition, the carbon nanotubes may comprise defects including vacancies or functional groups containing oxygen.

As described above, the bundled or entangled carbon nanotubes as the porous carbon material may have a porous structure in which spaces are formed between the carbon nanotubes as one or more carbon nanotubes are twisted or entangled.

The reduced graphene oxide (RGO) is the form of GO that is processed by chemical, thermal and other methods in order to reduce the oxygen content. The reduced graphene oxide may comprise a bent reduced graphene oxide, and may comprise bent and entangled reduced graphene oxides. Alternatively, the reduced graphene oxide may comprise crumpled reduced graphene oxides. As described above, the reduced graphene oxide included in the carbon composite may comprise one or more reduced graphene oxide entangled or crumpled, and the carbon composite may have a porous structure having spaces between the reduced graphene oxides.

In an exemplary embodiment of the present disclosure, the porous carbon material may comprise carbon nanotubes or reduced graphene oxide entangled or crumpled, and the average particle size (D₅₀) of the porous carbon material may be 10 to 80 μm. For example, entangled carbon nanotube strands may form the porous carbon material, and the average particle size (D₅₀) of each porous carbon material may correspond to the above-described numerical range.

In an exemplary embodiment of the present disclosure, the XRD peak of the carbon composite appears at 2θ.

In an exemplary embodiment of the present disclosure, a Raman peak intensity ratio, I_{G}/I_{D}, of the carbon composite may be 2.0 or less. Specifically, the intensity ratio I_{G}/I_{D} may be 0.5 or more to 2.0 or less. The intensity ratio (I_{G}/I_{D}) may be measured through peak intensity I_{G} and I_{D} values obtained from a spectrum of the carbon composite obtained through Raman spectroscopy. The Raman peak intensity ratio may be measured through I_{G} and I_{D} values obtained from the spectrum of the carbon composite obtained through Raman spectroscopy. In the obtained spectrum, I_{G} refers to a peak intensity for a crystalline portion (G-peak) and I_{D} refers to a peak intensity for non-crystalline portion (D-peak). Accordingly, a smaller I_{G}/I_{D} ratio indicates lower crystallinity. When the I_{G}/I_{D} ratio meets the above-described range, it is possible to maintain the optimal electrical conductivity and mechanical strength of the carbon composite.

In an exemplary embodiment of the present disclosure, the degree of crystallinity of the carbon composite may be 70% or more. The degree of crystallinity is measured using at least one of Raman spectroscopy analysis or XRD analysis. When the degree of crystallinity meets the above-described range, it is possible to prevent catalyst performance degradation while maintaining the optimal electrical conductivity, and maintain the resistance below a predetermined level.

In an exemplary embodiment, the carbon composite may further comprise N-doped amorphous carbon between a surface of the vanadium nitride particles and the surface of the porous carbon material. A molar ratio of the vanadium nitride particles to the N-doped amorphous carbon may be from 20:1 to 1:1.

The carbon composite of the present disclosure, which can be applied as a sulfur carrier or as a conductive material, comprises VN particles with reduced size and less particle agglomeration and has increased specific surface area, and substantially promotes the conversion reaction of LiPS to Li₂S, and thereby providing effects of reduced resistance and overvoltage.

Another aspect of the present disclosure provides a method of manufacturing the carbon composite for an electrode of a battery.

In an exemplary embodiment, the method of manufacturing the carbon composite includes a first step of forming a mixture of a porous carbon material, vanadium nitride or its precursor, a reducing agent, and a solvent; a second step of removing the solvent by filtering the mixture and drying the filtered mixture; and a third step of thermally treating the dried filtered mixture from the second step in an inert atmosphere.

In the first step, the precursor of the vanadium nitride may comprise at least one selected from dicyandiamide, ammonium metavanadate (NH₄VO₃), vanadium oxide, ammonia (NH₃) and ammonium chloride. For example, the vanadium nitride may be produced by reaction of dicyandiamide and ammonium metavanadate. Additionally, the reducing agent may comprise at least one selected from glucose, sucrose, lactose, fructose, starch, polydopamine and tannic acid.

The solvent used in the first step may comprise water and/or at least one organic solvent selected from the group consisting of dimethyl carbonate, dimethyl formamide, N-methyl formamide, sulfolane (tetrahydrothiophene-1,1-dioxide), 3-methyl sulfolane, N-butyl sulfone, dimethyl sulfoxide, pyrrolidinone (HEP), dimethyl piperidone (DMPD), N-methyl pyrrolidinone (NMP), N-methyl acetamide, dimethyl acetamide (DMAc), N,N-dimethyl formamide (DMF), diethyl acetamide (DEAc) dipropyl acetamide (DPAc), ethanol, propanol, butanol, hexanol, ethylene glycol, tetrachloroethylene, propylene glycol, toluene, turpentine, methyl acetate, ethyl acetate, petroleum ether, acetone, cresol and glycerol.

In an exemplary embodiment of the present disclosure, the amount of the vanadium nitride may be 1 to 100 parts by weight or 5 to 40 parts by weight, and the amount of the reducing agent may be 10 to 100 parts by weight or 20 to 80 parts by weight, based on 100 parts by weight of the porous carbon material. When the amounts of the vanadium nitride and the reducing agent meet the above-described range, an optimal level of vanadium nitride catalyst particles may be uniformly formed on the surface of the porous carbon material. Additionally, it is possible to minimize non-crystalline carbon having low electrical conductivity and expose the catalyst surface to the maximum extent while maintaining large specific surface area, thereby maximizing the reactivity of lithium polysulfide and preventing dissolution in the electrolyte solution.

In the first step, the components of the mixture are dispersed in the solvent and the dispersion may be performed by sonication and/or magnetic stirring.

In the second step, the solvent removal may be performed by vacuum filtration, and the drying may be performed in the temperature condition of 50° C. to 150° C. and may be performed for 1 to 48 hours.

The third step may include a first thermal treatment performed at 350° C. to 650° C., 500° C. to 650° C. or 550° C. to 650° C.; and a second thermal treatment performed at 650° C. to 1400° C., 700° C. to 900° C. or 750° C. to 850° C. In the first thermal treatment, the vanadium nitride is produced by pyrolysis and reduction of the vanadium nitride precursor, and in the second thermal treatment, the vanadium nitride particles are bonded to the surface of the porous carbon material by carbonization reaction. In particular, the third step may be performed in an inert atmosphere, and the inert atmosphere may be formed using at least one gas selected from helium, neon, argon, carbon dioxide and nitrogen.

In an exemplary embodiment of the present disclosure, when manufacturing the carbon composite comprising the vanadium nitride particles, NH₃, HF or acid having pKa of 4.0 or less is not used.

In another exemplary embodiment, the porous carbon material comprising carbon nanotubes may be used for manufacturing the carbon composite.

The method according to an embodiment of the present disclosure prevents agglomeration of the VN particles, thereby reducing size of the VN particles and increasing catalyst specific surface area, and provides a catalyst capable of substantially promoting the conversion reaction of LiPS to Li₂S.

According to yet another aspect of the present disclosure, provided herein is an electrode active material for an electrode of a battery, and the electrode active material may comprise a porous carbon support; and a sulfur containing material.

In an exemplary amendment, the porous carbon support is a sulfur carrier into the pores of which a sulfur containing material is impregnated, and the porous carbon support comprises the carbon composite according to an embodiment of the present disclosure.

In the present disclosure, the sulfur containing material, which is impregnated into the pores of the porous carbon support, may comprise an elemental sulfur (S₈), Li₂Sₙ (n≥1), a disulfide compound such as 2,5-dimercapto-1,3,4-thiadiazole or 1,3,5-trithiocyanuic acid, an organosulfur compound, carbon-sulfur polymers (C2Sx)n where x=2.5 to 50 and n≥2, or a mixture of two or more thereof. Preferably, the elemental sulfur (S₈) may be used.

When the sulfur containing material is impregnated into the carbon composite according to an embodiment of the present disclosure, a weight ratio of the sulfur containing material and the carbon composite may be 1:1 to 9:1, 2:1 to 8:1, 5:1 to 9:1 or 8:1 to 9:1. When the weight ratio of the sulfur or sulfide and the carbon composite meets the above-described range, it is possible to prevent particle agglomeration of the sulfur or sulfide, which makes it easy to accept electrons and allows the direct participation in electrode reaction, and control the optimal amount of binder necessary to prepare a positive electrode slurry, thereby preventing the increase in surface resistance of the electrode or cell performance degradation.

According to a further aspect, the present disclosure provides an electrode for a battery, which comprises a current collector; and an active material layer formed on a surface of the current collector.

In an exemplary embodiment, the active material layer may comprise the electrode active material according to an embodiment of the present disclosure and a conductive material.

The conductive material electrically connects the electrolyte solution to the electrode active material and acts as a path of movement of electrons from the current collector to the electrode active material, and may comprise any material having conductivity without limitation.

In another exemplary embodiment, the conductive material may comprise at least one of carbon black such as Super-P, denka black, acetylene black, ketjen black, channel black, furnace black, lamp black, thermal black, carbon black; carbon derivatives such as carbon nanotubes, graphene, fullerene; conductive fibers such as carbon fibers or metal fibers; metal powder such as fluoro carbon, aluminum, nickel powder; or conductive polymers such as polyaniline, polythiophene, polyacetylene, and polypyrrole. Additionally, the conductive material may comprise the carbon composite according to the present disclosure.

The conductive material may be included in an amount of 0.01 to 30 parts by weight based on 100 parts by weight of the electrode active material layer.

In an exemplary embodiment of the present disclosure, the electrode active material may be coated on the current collector to form the active material layer. The current collector is not limited to a particular material and may comprise any material that supports the electrode active material layer and has high conductivity without causing any chemical change to the corresponding battery. For example, the current collector may comprise copper; stainless steel; aluminum; nickel; titanium; palladium; sintered carbon; surface treated copper or stainless steel with carbon, nickel or silver; or an aluminum-cadmium alloy.

The current collector may have microtexture on the surface to enhance the bonding strength with the electrode active material, and may come in various forms, for example, films, sheets, foils, mesh, nets, porous bodies, foams or non-woven fabrics.

Thickness of the current collector is not particularly limited, but may be, for example, from 3 to 500 μm.

In another exemplary embodiment, the active material layer may further comprise a binder.

The binder serves to maintain the positive electrode active material on the positive electrode current collector and organically connect the positive electrode active material to increase the bonding strength between them, and may comprise any binder well known in the corresponding technical field. For example, the binder may comprise any one selected from the group consisting of a fluororesin binder including polyvinylidene fluoride (PVdF) or polytetrafluoroethylene (PTFE); a rubber-based binder including styrene butadiene rubber (SBR), acrylonitrile-butadiene rubber and styrene-isoprene rubber; a cellulose-based binder including carboxyl methyl cellulose (CMC), starch, hydroxypropyl cellulose and regenerated cellulose; a polyalcohol-based binder; a polyolefin-based binder including polyethylene and polypropylene; a polyimide-based binder; a polyester-based binder; a polyacrylate-based binder; and a silane-based binder or a mixture or copolymer thereof.

The binder may be added in an amount of 0.5 to 30 parts by weight when the total weight of the positive electrode active material layer is 100 parts by weight. When the amount of the binder meets the above-described range, it is possible to improve the physical properties of the positive electrode, prevent separation of the active material and the conductive material in the positive electrode, and control the optimal ratio of the active material and the conductive material in the positive electrode, thereby ensuring battery capacity.

According to a yet further aspect of the present disclosure, there is provided an electrode comprising a current collector; and an active material layer on at least one surface of the current collector, the active material layer comprising a porous carbon support into the pores of which a sulfur containing material is impregnated, a binder, and a conductive material, wherein the conductive material comprises the above-described carbon composite according to the present disclosure.

In an exemplary embodiment, when the conductive material is the above-described carbon composite in which vanadium nitride is formed on the surface of the porous carbon material, the conductive material may be included in an amount of 0.1 to 30 parts by weight based on 100 parts by weight of the positive electrode active material layer, and more specifically, 0.5 to 20 parts by weight, 1 to 10 parts by weight, or 1 to 5 parts by weight. When the relative content of the conductive material meets the above-described range, improved conduction of electrons between the active material particles or between the active material and the current collector, and reduced resistance in the electrode can be provided. In addition, as the conductive material is dispersed between the compressed active material particles, micropores are maintained between the active material particles, thereby allowing easy permeation of the electrolyte solution.

According to an exemplary embodiment of the present disclosure, the porous carbon support into the pores of which the sulfur containing material is impregnated may comprise conventionally used porous carbon supports for impregnation of sulfur containing material for lithium-sulfur batteries, or may comprise the carbon composite according to an embodiment of the present disclosure, which comprises vanadium nitride particles formed on the surface of the porous carbon material.

In an exemplary embodiment, the electrode may be a positive electrode of a lithium-sulfur battery (“Li—S battery”).

In another aspect of the present disclosure, provided herein is a battery, which comprises: a first electrode; a second electrode; a separator between the first electrode and the second electrode; and an electrolyte.

In an exemplary embodiment, some embodiments, the first electrode of the battery may comprise the carbon composite according to an embodiment of the present disclosure.

In another exemplary embodiment, the first electrode of the battery may comprise a porous carbon support and a sulfur containing material supported in the pores of the porous carbon support, and the carbon composite described above as a conductive material.

In yet another exemplary embodiment, the second electrode may be a lithium metal electrode.

According to yet another aspect, provided herein is a lithium-sulfur battery, which may comprise: a first electrode comprising the carbon composite according to an embodiment of the present disclosure and a sulfur containing material; a second electrode comprising a lithium metal; a separator between the first electrode and the second electrode; and an electrolyte.

The negative electrode, the separator and the electrolyte are not limited to particular types and may include any type that can be used in lithium-sulfur batteries without departing from the scope of the present disclosure.

According to a further aspect of the present disclosure, provided herein is a lithium-sulfur battery, which may comprise: a first electrode comprising an active material layer including a porous carbon support into the pores of which a sulfur containing material is impregnated and a conductive material comprising the carbon composite according to an embodiment of the present disclosure; a second electrode comprising a lithium metal; a separator between the first electrode and the second electrode; and an electrolyte.

In an exemplary embodiment of the present disclosure, the positive electrode for a lithium-sulfur battery may have a loading amount of 2.0 mg/cm² or more of sulfur containing material. For example, the loading amount of sulfur containing material in the positive electrode for a lithium-sulfur battery may be 2 to 10 mg/cm². When the loading amount meets the above-described range, improved operational stability may be obtained. In particular, the sulfur loading amount meeting the above-described range provides the improved operational stability at the reduced E/S ratio as described below.

In an exemplary embodiment of the present disclosure, the lithium-sulfur battery may have an electrolyte/sulfur (E/S) ratio of 10 μL/mg or less. For example, the E/S ratio of the lithium-sulfur battery may be 10 μL/mg or less, 8 μL/mg or less, 6 μL/mg or less, 4 μL/mg or less, or 2 μL/mg or less. Low activity of the positive electrode puts limitation on reduction in the E/S ratio. The positive electrode of a Li—S battery according to the present disclosure can stably reduce the E/S ratio, and the E/S ratio of the lithium-sulfur battery may have a larger value than the above-described range, and it is obvious to those skilled in the art that the lower limit is not limited to a particular value, and the present disclosure is not limited thereto.

Hereinafter, the present disclosure will be described in more detail through examples, but the following examples are provided to describe the present disclosure by way of illustration and the scope of the present disclosure is not limited thereto.

### Example 1. Carbon Composite Comprising Vanadium Nitride Particles Formed on Carbon Nanotubes (VN@CNT)

1.6 g of carbon nanotubes; 24 g of dicyandiamide and 0.8 g of ammonium metavanadate; and 0.2 g of glucose are mixed in a 500 mL solvent in which ethanol and water are mixed at a 1:1 volume ratio, and dissolved and dispersed through sonication and magnetic stirring.

Subsequently, the solvent except the vanadium nitride precursor adsorbed on the carbon nanotubes surface is removed through vacuum filtration.

Subsequently, drying is performed in a 80° C. oven for 12 hours.

Subsequently, thermal treatment is performed in a tube furnace of an inert atmosphere at 600° C. for 3 hours and at 800° C. for 2 hours to obtain a carbon composite in which vanadium nitride particles are present on the surface of the carbon nanotubes. In this instance, the amount of the vanadium nitride particles is 20 parts by weight based on 100 parts by weight of the obtained carbon composite. The amount of the vanadium nitride particles is measured using a thermogravimetric analyzer (TGA).

### Example 2. Carbon Composite Comprising Vanadium Nitride Particles Formed on Reduced Graphene Oxide Surface (VN@RGO)

The method of Example 1 is performed except that reduced graphene oxide is used instead of carbon nanotubes, to obtain a carbon composite in which vanadium nitride particles are present on the reduced graphene oxide surface. In this instance, the amount of the vanadium nitride particles is 20 parts by weight based on 100 parts by weight of the obtained carbon composite. The amount of the vanadium nitride particles is measured using a thermogravimetric analyzer (TGA).

### Comparative Example 1. Carbon Composite Comprising Vanadium Nitride Particles Formed on Amorphous Carbon (VN@C)

24 g of dicyanodiamide and 0.8 g of ammonium metavanadate; and 0.8 g of glucose are mixed in a 500 mL solvent in which ethanol and water are mixed at a 1:1 volume ratio, and dissolved and dispersed through sonication and magnetic stirring.

Subsequently, the solvent except the dicyanodiamide and ammonium metavanadate is removed through vacuum filtration.

Subsequently, drying is performed in a 80° C. oven for 12 hours.

Subsequently, thermal treatment is performed in a tube furnace of an inert atmosphere at 600° C. for 3 hours and at 800° C. for 2 hours to obtain a carbon composite in which vanadium nitride particles are present on the surface of amorphous carbon produced through a carbonization process from the glucose.

In this instance, the amount of the vanadium nitride particles is 20 parts by weight based on 100 parts by weight of the obtained carbon composite. The amount of the vanadium nitride particles is measured using a thermogravimetric analyzer (TGA).

The specific surface area, pore volume and average pore size of the carbon composite manufactured in Example 1, Example 2 and Comparative Example 1 are measured. The measurement results are shown in the following Table 1.

Specific Surface Area Measurement Method

The specific surface area, pore volume and average pore size of the carbon composite manufactured in Example 1, Example 2 and Comparative Example 1 are calculated from the amount of adsorbed nitrogen gas under liquid nitrogen temperature (77K) using BEL Japan's BELSORP-mino II.

TABLE 1

| | | Specific | Pore | Average | |
|---|---|---|---|---|---|
| | Carbon | surface area | volume | pore size | I_{G}/I_{D} |
| | composite | (m²/g) | (cm³/g) | (nm) | ratio |
| Example 1 | VN@CNT | 334.99 | 1.44 | 17.14 | 0.95 |
| Example 2 | VN@RGO | 337.78 | 2.44 | 28.94 | 0.95 |
| Comparative | VN@C | 220.37 | 0.77 | 13.95 | —(amorphous) |
| Example 1 | | | | | |

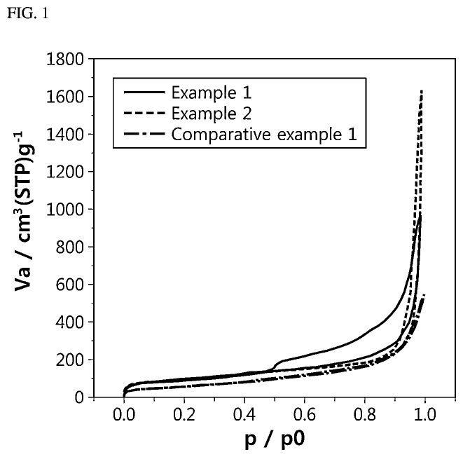

FIG. 1 shows 77K N₂ isotherm measurements of the carbon composite according to Example 1, Example 2 and Comparative Example 1, and Table 1 shows the specific surface area calculated using the BET equation. Additionally, the specific surface area and pore volume measurement results are shown in Table 1.

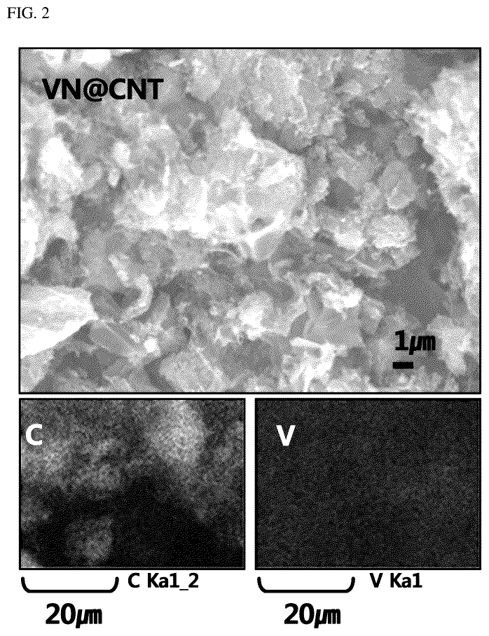

FIG. 2 is a scanning electron microscopy (SEM) image of the observed carbon composite of Example 1 in which the vanadium nitride particles are present on the surface of the carbon nanotubes. Specifically, the SEM image of FIG. 2 was obtained for the area of 10 μm×10 μm at 2,000× magnification.

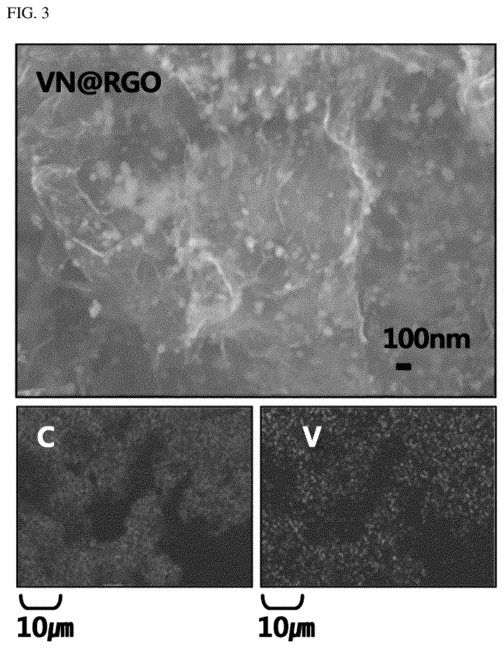

FIG. 3 is an SEM image of the observed carbon composite of Example 2 in which the vanadium nitride particles are present on the surface of the reduced graphene oxide. Specifically, the SEM image of FIG. 3 was obtained for the area of 10 μm×10 μm at 2,000× magnification.

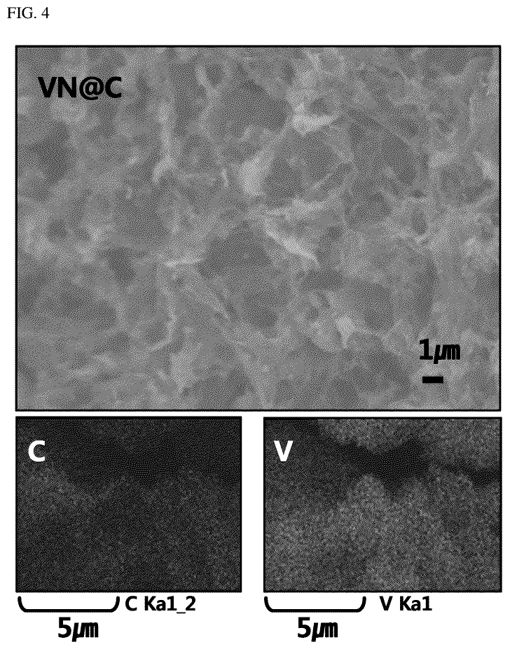

FIG. 4 is an SEM image of the observed carbon composite of Comparative Example 1 in which the vanadium nitride particles are present on the surface of the amorphous carbon such as carbon nanotubes. Specifically, the SEM image of FIG. 4 was obtained for the area of 10 μm×10 μm at 2,000× magnification.

Referring to FIGS. 2 to 4, it can be seen that the vanadium nitride particles are uniformly present on the surface of the carbon nanotubes, the reduced graphene oxide and the amorphous carbon, respectively. It can be seen that the vanadium nitride particles are significantly agglomerated since the average size of the vanadium nitride particles on the amorphous carbon surface is about 1 μm. In contrast, it can be seen that the average size of the vanadium nitride particles on the surface of the reduced graphene oxide or carbon nanotubes is 0.1 μm or less.

### Example 3. VN@CNT as Conductive Material

Manufacture of Positive Electrode

For a positive electrode active material, a porous carbon support in which sulfur (S₈) is impregnated into carbon nanotubes is prepared. In this instance, the weight ratio of the carbon composite and the sulfur is 1:3. The carbon composite of Example 1 as a conductive material and polyacrylic acid (PAA) as a binder are mixed with the positive electrode active material to prepare a positive electrode slurry.

In this instance, the weight ratio of the positive electrode active material, the conductive material and the binder is 88:5:7.

The slurry is coated on an aluminum foil using a Mathis coater and dried at the temperature of 50° C. for 24 hours, followed by rolling, to manufacture a positive electrode.

Manufacture of Lithium-Sulfur Battery

For a negative electrode, a 45 μm thick lithium metal thin film is prepared, and for an electrolyte, a mixture of 1M lithium bis(trifluoromethanesulfonyl)imide (LiTFSI) and 1 weight % of lithium nitrate (LiNO₃) dissolved in an organic solvent of 1,3-dioxolane and dimethyl ether (DOL:DME=1:1 (volume ratio)) is prepared.

The manufactured and prepared positive and negative electrodes are placed facing each other with a polyethylene separator having the thickness of 16 μm and porosity of 46% interposed between them, and 70 [symbol] of the electrolyte is injected to manufacture a lithium-sulfur battery.

### Example 4. VN@RGO as Conductive Material

A lithium-sulfur battery was manufacture by the same method as Example 3 except that the carbon composite of Example 2 was used instead of the carbon composite of Example 1 for a conductive material.

### Example 5. VN@CNT as Sulfur Carrier

Manufacture of Positive Electrode

A positive electrode active material is prepared, in which sulfur is impregnated into the carbon composite manufactured in Example 1 through a melt impregnation method. Specifically, the carbon composite and the sulfur (S₈) are blended and uniformly mixed. Subsequently, thermal treatment is performed in a 150° C. oven for 30 min to impregnate the sulfur into the carbon composite. In this instance, the weight ratio of the carbon composite and the sulfur is 1:3.

A polyacrylic acid (PAA) binder and a carbon fiber conductive material are mixed with the positive electrode active material to prepare a positive electrode slurry. In this instance, the weight ratio of the positive electrode active material, the conductive material and the binder in the slurry is 88:5:7.

The slurry is coated on an aluminum foil using a Mathis coater and dried at the temperature of 50° C. for 24 hours, followed by rolling, to manufacture a positive electrode.

Manufacture of Lithium-Sulfur Battery

For a negative electrode, a 45 μm thick lithium metal thin film is prepared, and for an electrolyte, a mixture of 1M lithium bis(trifluoromethanesulfonyl)imide (LiTFSI) and 1 weight % of lithium nitrate (LiNO₃) dissolved in an organic solvent of 1,3-dioxolane and dimethyl ether (DOL:DME=1:1 (volume ratio)) is prepared.

The manufactured and prepared positive and negative electrodes are placed facing each other with a polyethylene separator having the thickness of 16 μm and porosity of 46% disposed therebetween, and 70 [symbol] of the electrolyte is injected to manufacture a lithium-sulfur battery.

### Comparative Example 2. CNT as Conductive Material

A lithium-sulfur battery was manufacture by the same method as Example 3 except that CNT was used instead of the carbon composite of Example 1 for a conductive material.

### Comparative Example 3. VN@C as Conductive Material

A lithium-sulfur battery was manufacture by the same method as Example 3 except that the carbon composite of Comparative Example 1 was used instead of the carbon composite of Example 1 for a conductive material.

### Comparative Example 4. CNT as Sulfur Carrier

A lithium-sulfur battery was manufacture by the same method as Example 5 except that CNT was used instead of the carbon composite of Example 1 for a conductive material.

### Comparative Example 5

Manufacture of Positive Electrode

A positive electrode active material is prepared in which sulfur is impregnated into CNT through a melt impregnation method. Specifically, the carbon composite and the sulfur (S8) are blended and uniformly mixed. Subsequently, thermal treatment is performed in a 150° C. oven for 30 min to impregnate the sulfur into the carbon composite. In this instance, the weight ratio of the carbon composite and the sulfur is 1:3.

A polyacrylic acid (PAA) binder, a polyvinyl alcohol (PVA) thickening agent and a carbon nanotube conductive material are added to the positive electrode active material and mixed together to prepare a positive electrode slurry. In the slurry, the weight ratio of the positive electrode active material, the binder, the thickening agent and the conductive material is 88:6.5:0.5:5.

The slurry is coated on an aluminum foil using a Mathis coater and dried at the temperature of 50° C. for 24 hours, followed by rolling, to manufacture a positive electrode.

Manufacture of Lithium-Sulfur Battery

For a negative electrode, a 45 μm thick lithium metal thin film is prepared, and for an electrolyte, a mixture of 1M lithium bis(trifluoromethanesulfonyl)imide (LiTFSI) and 1 weight % of lithium nitrate (LiNO₃) dissolved in an organic solvent of 1,3-dioxolane and dimethyl ether (DOL:DME=1:1 (volume ratio)) is prepared.

The manufactured and prepared positive and negative electrodes are placed facing each other with a polyethylene separator having the thickness of 16 μm and porosity of 46% interposed between them, and 70 [symbol] of the electrolyte is injected to manufacture a lithium-sulfur battery.

<Evaluation of the Performance for the Lithium-Sulfur Battery>

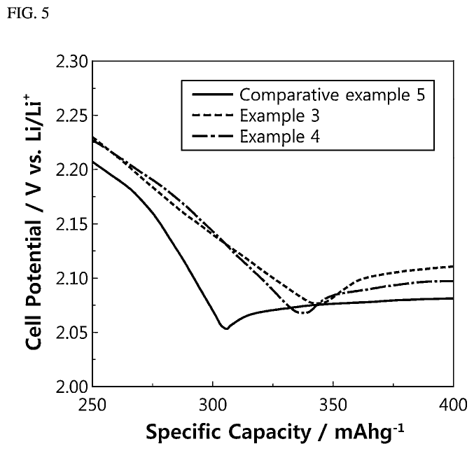

The performance of the lithium-sulfur batteries of Examples 3 to 5 and Comparative Examples 2 to 5 prepared above were evaluated by cyclic voltammetry (CV), and the results are shown in FIG. 5 to 9.

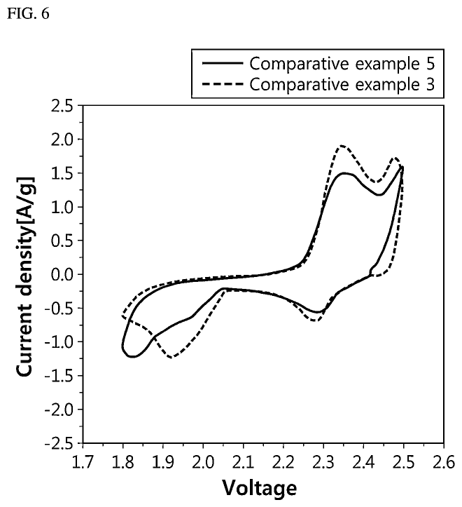

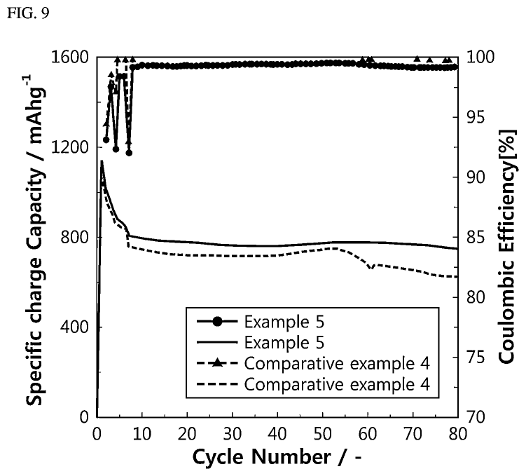

Specifically, in the voltage range of 1.7 V to 2.8 V (vs Li/Li+) for the battery to be evaluated, the first 3 charge/discharge was operated by 0.1C, the subsequent 3 charge/discharge was operated by 0.3C, and the subsequent charge/discharge was operated by 0.1C. Charging and discharging were repeated at a current density of 0.5C, and the capacity-voltage curves (FIGS. 5, 7, and 8), voltage-current density curves (FIG. 6) and cycle-specific capacity curves (FIG. 9) in the first cycle were shown.

Referring to FIG. 5, the batteries of Examples 3 and 4 using a carbon composite containing vanadium nitride particles on a porous carbon material as a positive electrode additive exhibit cell performance compared to the battery of Comparative Example 5 due to the catalytic activity of the vanadium nitride particles. Through this, it was confirmed that the overvoltage of the lithium sulfur battery could be improved due to the vanadium nitride particles and the conversion rate of lithium polysulfide to lithium sulfide could be improved. In particular, it was confirmed that Example 3 using carbon nanotubes could exhibit better performance than Example 4 using reduced graphene oxide.

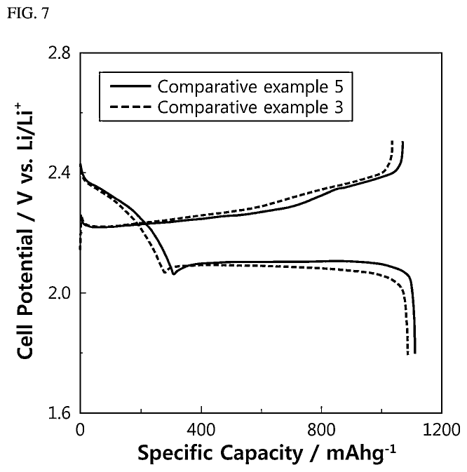

In addition, referring to FIGS. 6 and 7, the battery of Comparative Example 3 using the carbon composite of Comparative Example 1 in which the vanadium nitride particles are located on the surface of the amorphous carbon which the specific surface area is small and the amount of pores are small as the conductive material shows increased resistance due to low electrical conductivity of the amorphous carbon, and accordingly, it was confirmed that the performance was inferior to that of Comparative Example 5 using an anode not containing vanadium nitride particles.

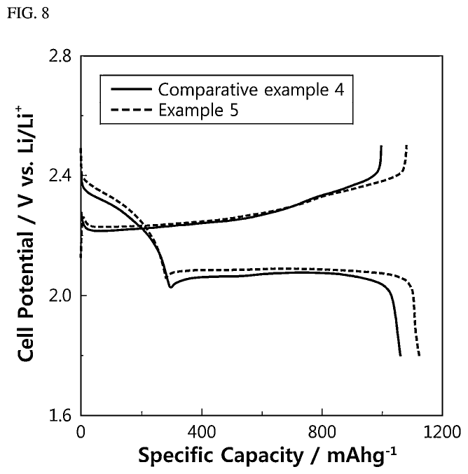

FIGS. 8 and 9 are performance evaluation graphs of the lithium-sulfur batteries of Example 5 and Comparative Example 4. It can be seen that the lithium-sulfur battery of Example 5 has improved performance by the overvoltage mitigation and conversion reaction promotion. Through this, it was confirmed that the performance of a lithium-sulfur battery can be improved by supporting sulfur (S8) in a carbon composite containing vanadium nitride particles on a porous carbon material and using it as a cathode active material.

Presumably, the carbon composite according to the present disclosure is more effective as a conductive material or as a sulfur carrier, each of which having catalyst uniformly distributed thereon for promoting conversion reaction of LiPS to Li₂S, than conductive material conventionally used in a positive electrode of a lithium sulfur battery, but advantageous effects of the present disclosure are not limited thereto.

It should be understood that the detailed description and specific examples above, while indicating preferred embodiments of the disclosure, are given by way of illustration only, since various changes and modifications within the scope of the disclosure will become apparent to those skilled in the art from this detailed description.

What is claimed is:

1. A carbon composite for an electrode of a battery, the carbon composite comprising:
a porous carbon material; and
vanadium nitride particles formed on a surface of the porous carbon material.

2. The carbon composite according to claim 1, wherein an average particle size of the vanadium nitride particles is 200 nm or less.

3. The carbon composite according to claim 1, wherein a specific surface area of the carbon composite is 250 m²/g or more.

4. The carbon composite according to claim 1, wherein a pore volume of the carbon composite is 1.0 cm³/g or more.

5. The carbon composite according to claim 1, wherein a content of the vanadium nitride particles in the carbon composite is 3 parts by weight or more and 50 parts by weight or less based on 100 parts by weight of the carbon composite.

6. The carbon composite according to claim 1, wherein the porous carbon material comprises carbon nanotubes, reduced graphene oxide, or a mixture thereof.

7. The carbon composite according to claim 1, where in the porous carbon material comprises carbon nanotubes.

8. The carbon composite according to claim 1, wherein a Raman peak intensity ratio, I_{G}/I_{D}, of the carbon composite is 2.0 or less, wherein I_{G} is a peak intensity for a crystalline portion and I_{D} is a peak intensity for a non-crystalline portion in a Raman spectrum.

9. A method of manufacturing the carbon composite according to claim 1, the method comprising:
forming a mixture of a porous carbon material, vanadium nitride or its precursor, a reducing agent, and a solvent;
removing the solvent by filtering the mixture and drying the filtered mixture; and
thermally treating the dried filtered mixture in an inert atmosphere,
wherein the thermally treating comprises a first thermal treatment performed at 350 to 650° C. and a second thermal treatment performed at 650 to 1400° C.

10. The method according to claim 14, wherein the porous carbon material comprises carbon nanotubes, reduced graphene oxide, or a mixture thereof.

11. An electrode active material comprising the carbon composite according to claim 1; and a sulfur containing material.

12. The electrode active material according to claim 11, wherein the sulfur containing material comprises an elemental sulfur (S₈), Li₂Sₙ where n≥1, disulfide compounds, organosulfur compounds, carbon-sulfur polymers (C₂Sₓ)ₙ where x=2.5 to 50 and n≥2, or a mixture of two or more thereof.

13. The electrode active material according to claim 11, wherein a content ratio of the sulfur containing material to the carbon composite ranges from 1:1 to 9:1 by weight.

14. An electrode comprising:
a current collector; and
an active material layer formed on a surface of the current collector,
wherein the active material layer comprises the electrode active material according to claim 11, a binder, and a conductive material.

15. An electrode comprising:
a current collector; and
an active material layer formed on a surface of the current collector,
wherein the active material layer comprises a porous carbon support and a sulfur containing material supported in pores thereof, a binder, and a conductive material,
wherein the conductive material comprises the carbon composite of claim 1.

16. A battery comprising:
a first electrode comprising a carbon composite;
a second electrode;
a separator between the first electrode and the second electrode; and
an electrolyte,
wherein the carbon composite comprises a porous carbon material and vanadium nitride particles formed on a surface of the porous carbon material.

17. A battery comprising:
a first electrode;
a second electrode;
a separator between the first electrode and the second electrode; and
an electrolyte,
wherein the first electrode is the electrode according to claim 14.

18. A lithium-sulfur battery comprising:
a first electrode comprising a carbon composite and a sulfur containing material;
a second electrode comprising a lithium metal;
a separator between the first electrode and the second electrode; and
an electrolyte,
wherein the first electrode is the electrode according to claim 15.

19. A lithium-sulfur battery comprising:
a first electrode;
a second electrode comprising a lithium metal;
a separator between the first electrode and the second electrode; and
an electrolyte,
wherein the first electrode is the electrode according to claim 14.
